(19) United States
(12) Patent Application Publication
(10) Pub. No.: US 2006/0188160 A1
(43) Pub. Date: Aug. 24, 2006

(54) Device, method, and computer-readable medium for detecting changes in objects in images and their features

(76) Inventors: Nobuyuki Matsumoto, Kawasaki-shi (JP); Takashi Ida, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/311,483

(22) Filed: Dec. 20, 2005

Related U.S. Application Data
(62) Division of application No. 09/984,688, filed on Oct. 31, 2001.

(30) Foreign Application Priority Data
Oct. 31, 2000 (JP) 2000-333211
Sep. 28, 2001 (JP) 2001-303409

(51) Int. Cl. G06K 9/46

(52) U.S. Cl. 382/190

(57) ABSTRACT

A feature pattern (e.g., contours of an object) of an input image to be processed is extracted. A feature pattern (e.g., contours of an object) of a reference image corresponding to the input image is extracted. A comparison is made between the extracted feature patterns of the input and reference images. Their difference is output as the result of the comparison.

### CROSS-REFERENCE TO RELATED APPLICATIONS

This is a divisional application of Ser. No. 09/984,688, filed Oct. 31, 2001 which is based upon and claims the benefit of priority from the prior Japanese Patent Applications No. 2000-333211, filed Oct. 31, 2000; and No. 2001-303409, filed Sep. 28, 2001, the entire contents of each of which are incorporated herein by reference.

### BACKGROUND OF THE INVENTION

1. Field of the Invention

The present invention relates to an apparatus, method, and a computer-readable medium for detecting changes in objects in images and corners as the features of the objects.

2. Description of the Related Art

As a technique to exercise supervision and inspection using images shot with an electronic camera, a background differencing method is known. This is a technique which, through comparison between a background image shot in advance and an input image shot with an electronic camera, allows changes in the input image to be detected with ease.

According to the background differencing, a background image serving as a reference image is shot in advance and then an image to be processed is input for comparison with the reference image. For example, assume here that the input image is as shown in FIG. 40A and the background image is as shown in FIG. 40B. Then, the subtraction of the input image and the reference image will yield the result as shown in FIG. 40C. As can be seen from FIG. 40C, changes in the upper left of the input image which are not present in the background image are extracted.

With the background differencing, since all changes in brightness that appear on an image are to be detected, there arises a problem of the occurrence of erroneous detection in the event of occurrence of any change in brightness in the background region of the input image. Further, in the event of a camera shake at the time of shooting an image to be processed, the background of the resulting image will move along the direction of the shake and the moved region may be detected in error.

As a method of detecting the corners of objects from an image, the SUSAN operator is known (the reference 1 “SUSAN-a new approach to low level image processing”, S. M. Steve and M. Brady, International Journal on Computer Vision, 23(1), pp. 45-47, 1997).

This conventional corner detecting method fails to detect corners correctly if the input image is poor in contrast. Also, spot-like noise may be detected in error.

### BRIEF SUMMARY OF THE INVENTION

It is an object of the present invention to provide a device, method, and computer-readable medium for allowing changes in objects to be detected exactly without being affected by changes in lightness in the background region of an input image and camera shakes.

It is another object of the present invention to provide a method and computer-readable medium for allowing corners of objects to be detected exactly even in the event that the contrast of an input image is poor and spot-like noise is present.

According to one aspect of the invention, there is provided a method comprising extracting a feature pattern from an input image that depicts an object; extracting a feature pattern from a reference image corresponding to the input image, the reference image being generated in advance of the input image; and comparing the extracted feature pattern of the input image and the extracted feature pattern of the reference image to detect a change in the object.

### BRIEF DESCRIPTION OF THE SEVERAL VIEWS OF DRAWING

FIG. 1A is a block diagram of an image processing device according to a first embodiment of the present invention;

FIG. 1B is a block diagram of a modification of the image processing device shown in FIG. 1;

FIG. 2 is a flowchart for the image processing according to the first embodiment;

FIG. 3A is a diagram for use in explanation of the operation of the first embodiment and shows contours extracted from an input image;

FIG. 3B is a diagram for use in explanation of the operation of the first embodiment and shows contours extracted from a reference image;

FIG. 3C is a diagram for use in explanation of the operation of the first embodiment and shows the result of comparison between the contours extracted from the input and reference images;

FIG. 4 shows the procedure of determining contours of an object in an input image using contours in a reference image as a rough shape in accordance with the first embodiment;

FIG. 5A is a diagram for use in explanation of the operation of a second embodiment of the present invention and shows corners extracted from an input image;

FIG. 5B is a diagram for use in explanation of the operation of the second embodiment and shows corners extracted from a reference image;

FIG. 5C is a diagram for use in explanation of the operation of the second embodiment and shows the result of comparison between the corners extracted from the input and reference images;

FIG. 6 is a block diagram of an image processing device according to a third embodiment of the present invention;

FIG. 7 is a flowchart illustrating the procedure for image processing according to the third embodiment;

FIG. 8 is a flowchart illustrating the outline of the process of detecting the vertex of a corner in an image as a feature point in accordance with a fifth embodiment of the present invention;

FIG. 9 shows placement of square blocks similar to each other;

FIG. 10A shows a relationship between a block placed in estimated position and an object image;

FIG. 10B shows a relationship among the block placed in estimated position, a block similar to the block, and the object image;

FIG. 10C shows the intersection of straight lines passing through corresponding vertexes of the block placed in estimated position and the similar block and the vertex of a corner of the object;

FIG. 11 shows an example of an invariant set derived from the blocks of FIG. 9;

FIG. 12 shows examples of corners which can be detected using the blocks of FIG. 9;

FIG. 13 shows another example of square blocks similar to each other;

FIG. 14 shows an example of an invariant set derived from the blocks of FIG. 13;

FIG. 15 shows an example of blocks different in aspect ratio;

FIG. 16 shows an example of an invariant set derived from the blocks of FIG. 15;

FIG. 17 shows examples of corners which can be detected using the blocks of FIG. 15;

FIG. 18 shows an example of a similar block different in aspect ratio;

FIG. 19 shows an example of an invariant set derived from the blocks of FIG. 18;

FIG. 20 shows examples of corners which can be detected using the blocks of FIG. 18;

FIG. 21 shows an example of blocks different in aspect ratio;

FIG. 22 shows an example of an invariant set derived from the blocks of FIG. 21;

FIG. 23 shows examples of corners which can be detected using the blocks of FIG. 21;

FIG. 24 shows an example of a similar block which is distorted sideways;

FIG. 25 shows an example of an invariant set derived from the blocks of FIG. 24;

FIG. 26 shows examples of corners which can be detected using the blocks of FIG. 24;

FIG. 27 is a diagram for use in explanation of the procedure of determining transformation coefficients in mapping between two straight lines the slopes of which are known in advance;

FIG. 28 shows an example of a similar block which is tilted relative to the other;

FIG. 29 shows an example of an invariant set derived from the blocks of FIG. 28;

FIG. 30 shows an example of a feature point (the center of a circle) which can be detected using the blocks of FIG. 28;

FIG. 31 shows an example of a similar block which is the same size as and is tilted with respect to the other;

FIG. 32 shows an example of an invariant set derived from the blocks of FIG. 31;

FIG. 33 shows examples of corners which can be detected using the blocks of FIG. 31;

FIG. 34 shows an example of a similar block which is of the same height as and larger width than the other;

FIG. 35 shows an example of an invariant set derived from the blocks of FIG. 34;

FIG. 36 shows an example of a straight line which can be detected using the blocks of FIG. 34;

FIG. 37 is a flowchart for the corner detection using contours in accordance with a sixth embodiment of the present invention;

FIGS. 38A through 38F are diagrams for use in explanation of the steps in FIG. 37;

FIG. 39 is a diagram for use in explanation of a method of supporting the position specification in accordance with the sixth embodiment; and

FIGS. 40A, 40B and 40C are diagrams for use in explanation of prior art background differencing.

### DETAILED DESCRIPTION OF THE PREFERRED EMBODIMENT

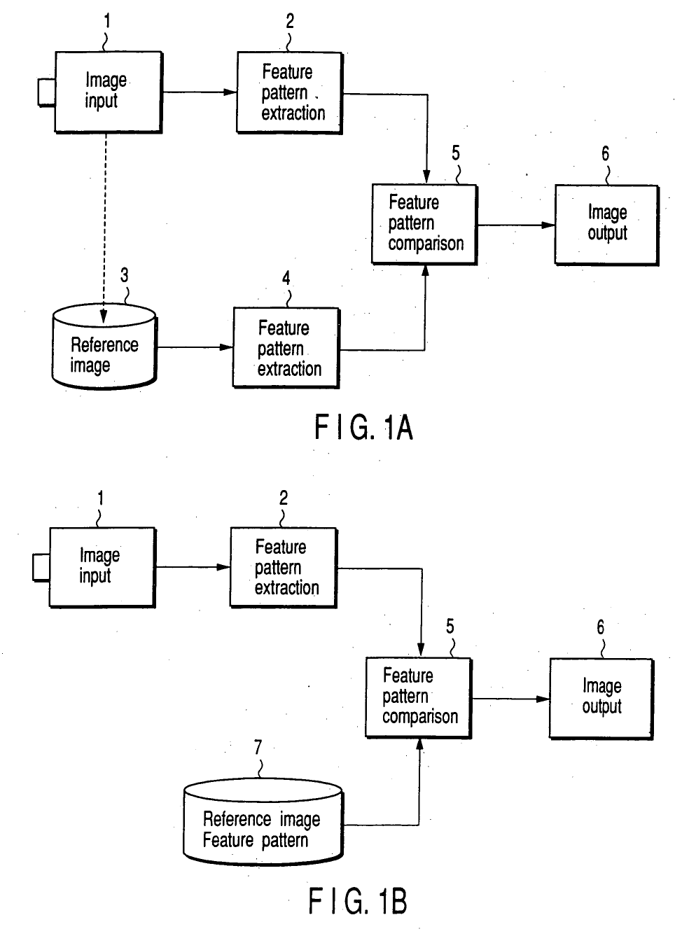

Referring now to FIGS. 1A and 1B, there are illustrated, in block diagram form, image processing devices according to a first embodiment of the present invention. In the image processing device of FIG. 1A, an image input unit 1, which consists of, for example, an image pickup device such as a video camera or an electronic still camera, receives an optical image of an object, and produces an electronic input image to be processed.

The input image from the image input unit 1 is fed into a first feature pattern extraction unit 2 where the feature pattern of the input image is extracted. A reference image storage unit 3 is stored with a reference image corresponding to the input image, for example, an image previously input from the image input unit 1 (more specifically, an image obtained by shooting the same object). The reference image read out of the reference image storage unit 3 is input to a second feature pattern extraction unit 4 where the feature pattern of the reference image is extracted.

The feature patterns of the input and reference images respectively extracted by the first and second feature extraction units 2 and 4 are compared with each other by a feature pattern comparison unit 5 whereby the difference between the feature patterns is obtained. The result of comparison by the comparison unit 5, e.g., the difference image representing the difference between the feature patterns, is output by an image output unit 6 such as an image display device or recording device.

FIG. 1B illustrates a modified form of the image processing device of FIG. 1A. In this device, in place of the reference image storage unit 3 and the feature pattern extraction unit 4 in FIG. 1A, use is made of a reference image feature pattern storage unit 7 which stores the previously obtained feature pattern of the reference image. The feature pattern of the reference image read from the storage unit 7 is compared with the feature pattern of the input image in the comparison unit 5.

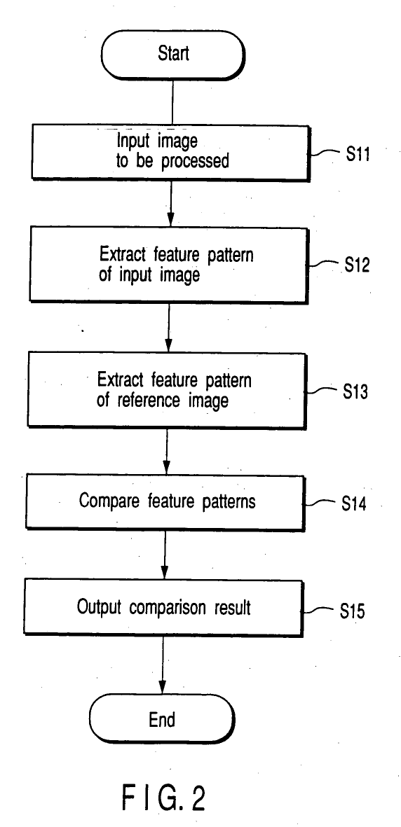

Next, the image processing procedure of this embodiment will be described with reference to a flowchart shown in FIG. 2.

First, an image to be processed is input through a camera by way of example (step S11). Next, the feature pattern of the input image is extracted (step S12). As the feature pattern of the input image, contours in the input image (particularly, the contours of objects in the input image) are detected, which are not associated with the overall change in the brightness of the image. To detect contours, existing contour extraction methods can be used, which include contour extraction methods (for example, the reference 2 “Precise Extraction of Subject Contours using LIFS” by Ida, Sanbonsugi, and Watanabe, Institute of Electronics, Information and Communication Engineers, D-II, Vol. J82-D-II, No. 8, pp. 1282-1289, August 1998), snake methods using dynamic contours, etc.

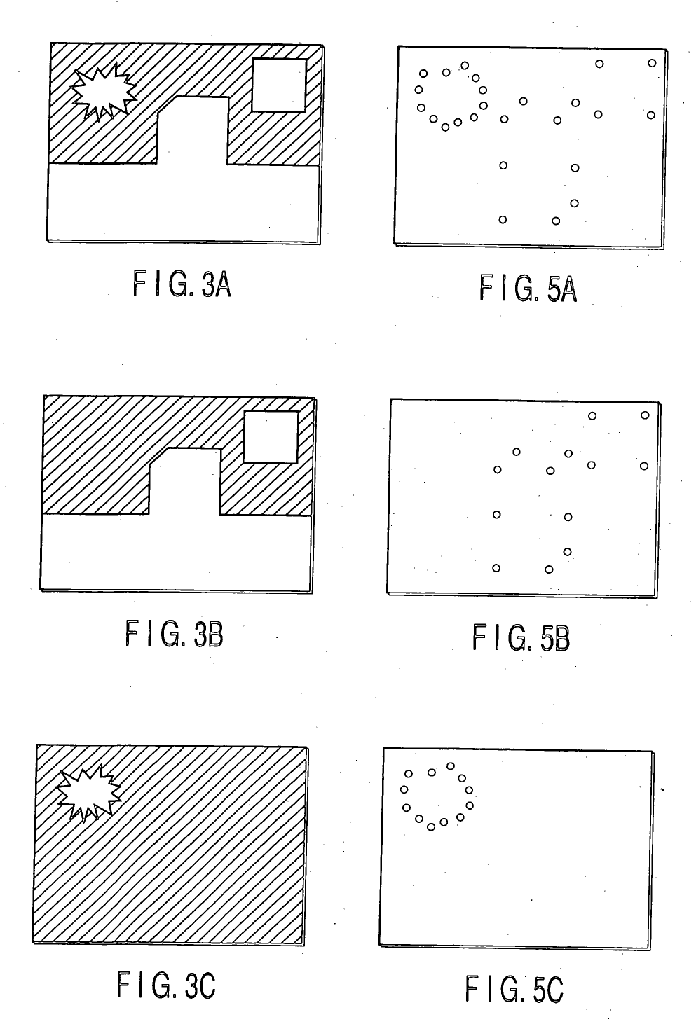

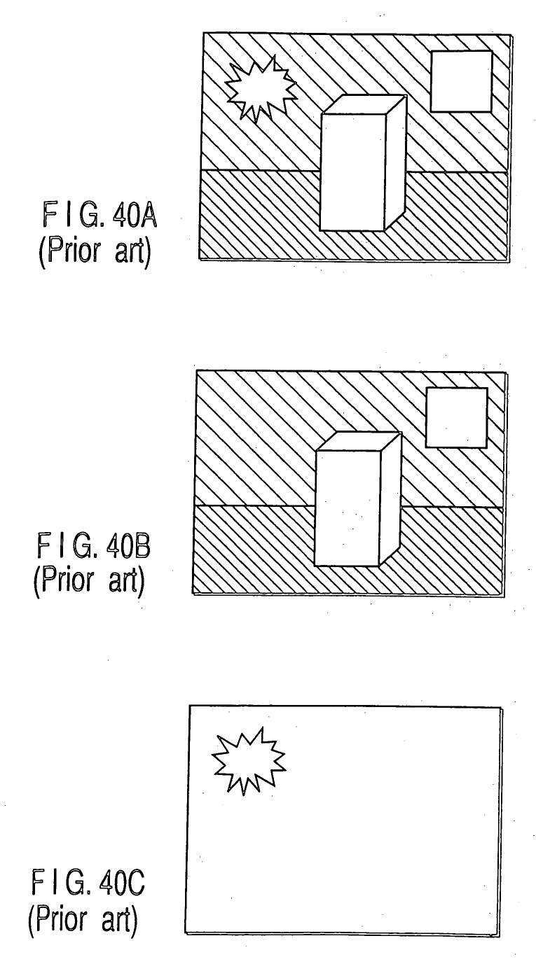

Assuming that the image shown in FIG. 40A is input as with the background differencing method described previously, such contours as shown in FIG. 3A are extracted in step S12 as the feature pattern of the input image. As in the case of the input image, the contours of objects in the reference image are also extracted as its feature pattern (step S13). Assuming that the reference image is as shown in FIG. 40B, such contours as shown in FIG. 3B are extracted in step S13 as the feature pattern of the reference image.

When the image processing device is arranged as shown in FIG. 1A, the process in step S13 is carried out by the second feature pattern extraction unit 4. In the arrangement of FIG. 1B, the process in step S13 is performed at the stage of storing the feature pattern of the reference image into the storage unit 7. Thus, step S13 may precede step S11.

Next, a comparison is made between the feature patterns of the input and reference images through subtraction thereof by way of example (step S14). The result of the comparison is then output as an image (step S15). The difference image, representing the result of the comparison between the image of contours in the input image of FIG. 3A and the image of contours in the reference image of FIG. 3B, is as depicted in FIG. 3C. In the image of FIG. 3C, changes present in the upper left portion of the input image are extracted.

Thus, in this embodiment, to detect changes in the input image, use is made of the contours of objects in the images, not the luminance itself of the images that is greatly affected by variations in lightness. Even if the lightness varies in the background region of the input image, therefore, changes of objects can be detected with precision.

In order to use the method described in the reference 2 or the snake method in extracting the contours of objects in steps S12 and S13, it is required to know the broad shapes of objects in the image in the beginning. For the reference image, the broad shapes of objects are defined through manual operation to extract their contours. For the input image as well, the broad shapes of objects may be defined through manual operation; however, the use of the extracted contours of objects in the reference image as the broad shapes of objects in the input image will allow the manual operation to be omitted with increased convenience.

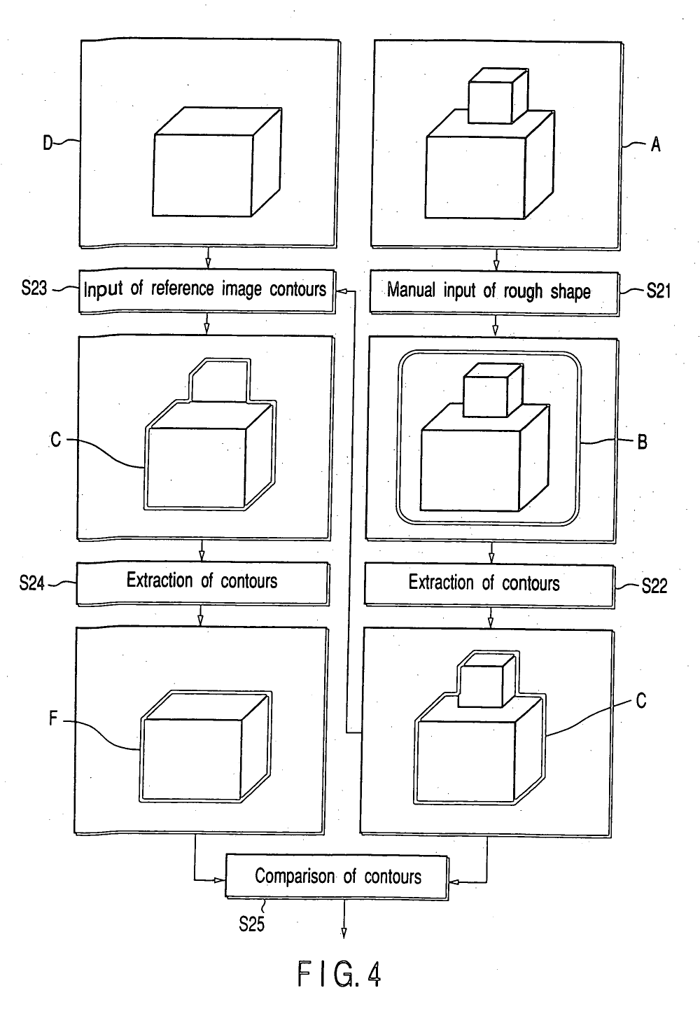

Hereinafter, reference is made to FIG. 4 to describe the procedure of determining the contours of objects in the input image with the contours of objects in the reference image as the broad shapes. First, a broad shape B is input so as to enclose an object through manual operation on the reference image A (step S21). Next, contours C of the object within a frame representing the broad shape B are extracted as the contours in the reference image (step S22). Next, the contours C in the reference image extracted in step S22 are input to the input image D (step S23) and then contours F in the input image D within the contours C in the reference image are extracted (step S24). Finally, a comparison is made between the contours C in the reference image extracted in step S22 and the contours F in the input image extracted in step S24 (step S25).

According to such an image processing method, a camera-based supervision system can be automated in such a way that contours in the normal state are extracted and held in advance as contours for a reference image and contours are extracted from each of input images captured at regular intervals of time and then compared in sequence with the normal contours to produce a warning audible signal in the event of a difference of an input image from the reference image.

A second embodiment of the present invention will be described next. The arrangement of an image processing device of the second embodiment remains unchanged from the arrangements shown in FIGS. 1A and 1B. The procedure also remains basically unchanged from that shown in FIG. 2. The second embodiment differs from the first embodiment in the method of extracting feature patterns from input and reference images.

In the first embodiment, the contours of an object are extracted as feature patterns of input and reference images which are not associated with overall variations in the lightness of images. In contrast, the second embodiment extracts corners of objects in images as the feature patterns thereof. Based on the extracted corners, changes of the objects in images are detected. To detect corners, it is advisable to use a method used in a fifth embodiment which will be described later.

Other corner detecting methods can be used which include the method using the determinant of Hesse matrix representing the curvature of an image as a two-dimensional function, the method based on Gauss curvature, and the previously described SUSAN operator.

As in the first embodiment, it is assumed that the input image is as depicted in FIG. 40A and the reference image is as depicted in FIG. 40B. In the second embodiment, in steps S12 and S13 in FIG. 2, such corners as shown in FIGS. 5A and 5B are detected as the feature patterns of the input and reference images, respectively.

When the input image feature pattern and the reference image feature pattern obtained through the corner extraction processing are subtracted in step S14 in FIG. 2, the output of step S15 is as depicted in FIG. 5C.

Thus, in the second embodiment, as in the first embodiment, changes of objects can be detected with precision by detecting changes in the input image through the use of the corners of objects in the input and reference images even if the lightness varies in the background region of the input image.

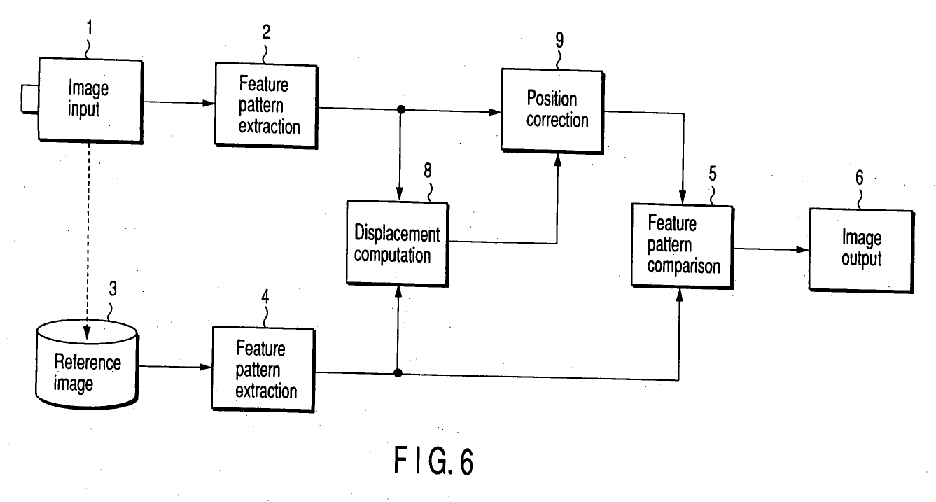

A third embodiment of the present invention will be described next. FIG. 6 is a block diagram of an image processing device according to the third embodiment in which a positional displacement calculation unit 8 and a position correction unit 9 are added to the image processing devices of the first embodiment shown in FIGS. 1A and 1B.

The positional displacement calculation unit 8 calculates a displacement of the relative position of feature patterns of the input and reference images respectively extracted in the first and second extraction units 2 and 4. The position correction unit 9 corrects at least one of the feature patterns of the input and reference images on the basis of the displacement calculated by the positional displacement calculation unit 8. In the third embodiment, the position correction unit 9 corrects the feature pattern of the input image. The feature pattern of the input image after position correction is compared with the feature pattern of the reference image in the comparator 5 and the result is output by the image output unit 6.

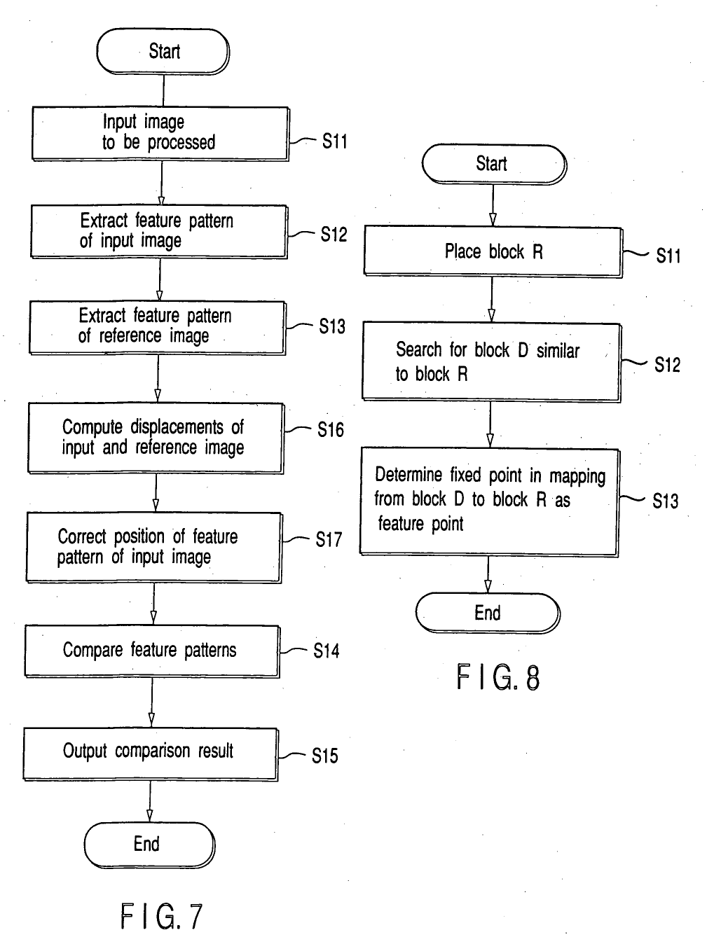

The image processing procedure in the third embodiment will be described with reference to a flowchart shown in FIG. 7. In this embodiment, step S16 of calculating a displacement of the relative position of the feature patterns of the input and reference images and step S17 of correcting the position of the feature pattern of the input image on the basis of the displacement in position calculated in step S16 are added to the procedure of the first embodiment shown in FIG. 2.

In the first and second embodiments, the difference between the feature patterns of the input and reference images is directly calculated in step S15 in FIG. 2. In contrast, in this embodiment, in step S15 the input image feature pattern after being corrected in position in step S17 is compared with the reference image feature pattern with the corners of objects taken as the feature pattern as in the second embodiment.

In step S16, calculations are made as to how far the corners in the input image extracted in step S12 and the corners in the reference image extracted in step S13 are offset in position from previously specified reference corners. Alternatively, the displacements of the input and reference images are calculated from all the corner positions. In step S17, based on the displacements calculated in step S16, the feature pattern of the input image is corrected in position so that the displacement of the input image feature pattern relative to the reference image feature pattern is eliminated.

Thus, in this embodiment, even if there is relative displacement between the input image and the reference image, their feature patterns can be compared in the state where the displacement has been corrected, allowing exact detection of changes in objects.

Moreover, according to this embodiment, when shooting moving video images the use of an image one frame before an input image in the image sequence as the reference image allows hand tremors to be compensated for.

Next, a fourth embodiment of the present invention will be described. The arrangement of an image processing device of this embodiment remains unchanged from the arrangement of the third embodiment shown in FIG. 6 and the process flow also remains basically unchanged from that shown in FIG. 7. The fourth embodiment differs from the third embodiment in the contents of processing.

In the third embodiment, the corners of objects in images are extracted as the feature patterns of the input and reference images in steps S12 and S13 of FIG. 7 and the processes in steps S16, S17 and S14 are all performed on the corners of objects. In contrast, in the fourth embodiment, the displacement of the corners of objects used in the third embodiment is utilized for the image processing method which detects changes in objects using the difference between contour images described as the first embodiment.

That is, the position of the contour image of the input image is first corrected based on the relative displacement of the input and reference images calculated from the corners of objects in the input and reference images and then the contour image of the input image and the contour image of the reference image are subtracted to detect changes in objects in the input image. In this case, in steps S12 and S13 in FIG. 7, two feature patterns of corners and contours are extracted from each of the input and reference images. In step S16, the feature pattern of corners is used and, in step S14, the feature pattern of contours is used.

According to this embodiment, even in the event that changes in lightness occur in the background region of the input image and the input image is blurred, changes in objects in the input image can be detected with precision.

Next, a fifth embodiment of the present invention will be described, which is directed to a new method to detect corners of objects in an image as its feature pattern. In this embodiment, a process flow shown in FIG. 8 is used to detect the corners of objects in steps S12 and S13 of FIG. 7 in the third and fourth embodiments.

FIG. 8 is a flowchart roughly illustrating the procedure of detecting a feature point, such as the vertex of a corner in an image, in accordance with the fifth embodiment. First, in step S11, a block R is disposed in a location for which a feature point is estimated to be present nearby. The block R is an image region of a square shape. A specific example of the block will be described.

For example, in the case of moving video images, the block R is disposed with the location in which a feature point was present in the past as the center. When the user specifies and enters the rough location of the vertex of a corner while viewing an image, the block R is disposed with that location as the center. Alternatively, a plurality of blocks is disposed in sequence when feature points are extracted from the entire image.

Next, in step S12, a search is made for a block D similar to the block R.

In step S13, a fixed point in mapping from the block D to the block R is determined as a feature point.

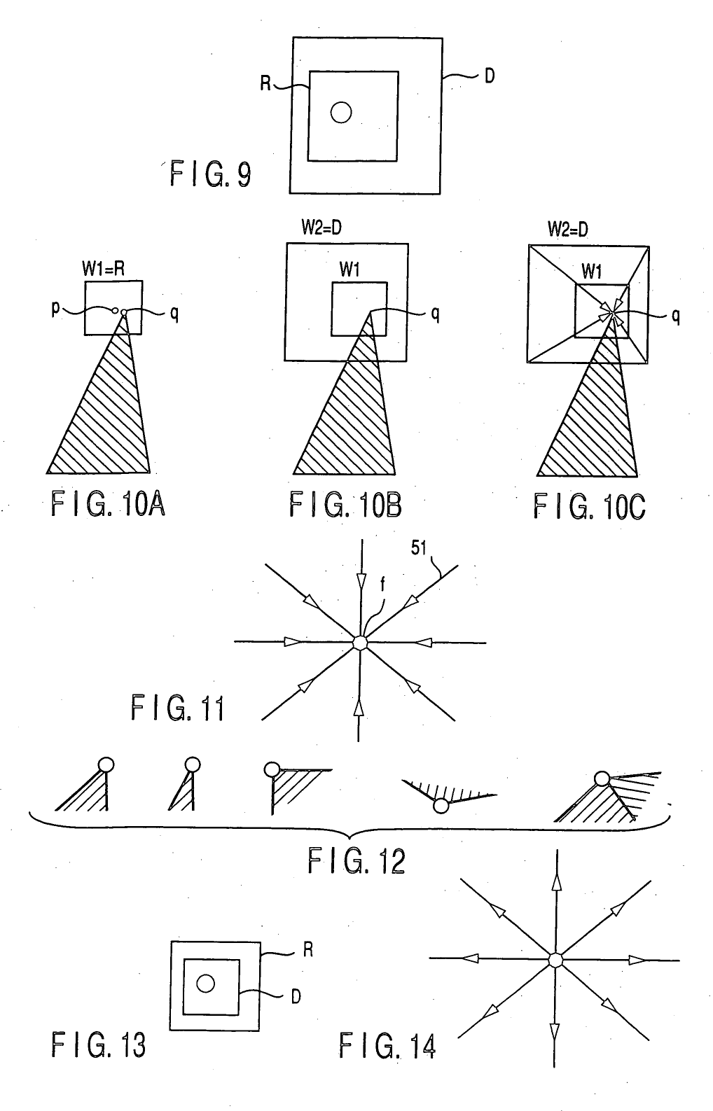

Here, an example of the block R and the block D is illustrated in FIG. 9. In this example, the block D and the block R are both square in shape with the former being larger than the latter. The black dot is a point that does not move in the mapping from the block D to the block R, i.e., the fixed point. FIGS. 10A, 10B and 10C illustrate the manner in which the fixed point becomes coincident with the vertex of a corner in the image.

In FIGS. 10A to 10C, W1 corresponds to the block R and W2 corresponds to the block D. With the location in which a corner is estimated or specified to be present taken as p, the result of disposition of the block W1 with p as its center is as depicted in FIG. 10A. The hatched region indicates an object. In general, the vertex q of a corner of an object is displaced from p (however, they may happen to coincide with each other). The result of search for the block W2 similar to the block W1 is shown in FIG. 10B, from which one can see that the blocks W1 and W2 are similar in shape to each other.

Here, let us consider the mapping from block W2 to block W1. The fixed point for the mapping coincides with the vertex of the object corner as shown in FIG. 10C. Geometrically, the fixed point for mapping is the intersection of at least two straight lines that connect corresponding vertexes of the blocks W1 and w2. That, in the mapping between similar blocks, the fixed point coincides with the vertex of a corner of an object will be described in association with the (invariant set) of mapping.

FIG. 11 illustrates the fixed point (black dot) f in the mapping from block D to block R and the invariant set (lines with arrows). The invariant set refers to a set that makes no change before and after the mapping. For example, even when mapping is performed onto a point on the invariant set (lines in this example) 51, the map is inevitably present on one line in the invariant set 51. The arrows in FIG. 11 indicates the directions in which points are moved through mapping.

The figure of the invariant set as shown in FIG. 11 does not change through mapping. Any figure obtained by combining any portions of the invariant set as shown in FIG. 11 does not change through mapping. For example, a figure composed of some straight lines shown in FIG. 11 will also not change through mapping. When such a figure as composed of lines is taken as a corner, its vertex coincides with the fixed point f for mapping.

Thus, if a reduced block of the block D shown in FIG. 10B contains exactly the same image data as the block R, the contours of an object is contained in the invariant set and the vertex q of the corner coincides with the fixed point f.

When the mapping is represented by affine transformation:
x_new=a*x_old+b*y_old+e,
y_new=c*x_old+d*y_old+f,
where (x_new, y_new) are x- and y-coordinates after mapping, (x_old, y_old) are x- and y-coordinates before mapping, and a, b, c, d, e, and f are transform coefficients,
the coordinates of the fixed point, (x_fix, y_fix), are given, since x new=x old and y new=y old, by
x_fix={(d−1)*e−b*f}/{b*c−(a−1)*(d−1)}
y_fix={(a−1)*f−c*e}/{b*c−(a−1)*(d−1)}

The example of FIG. 9 corresponds to the case where a=d<1 and b=c=0. The values for a and d are set at, say, ½ beforehand. Here, the search for a similar block is made by, while changing the values for e and f, sampling pixel values in the block D determined tentatively by values for e and f, determining the deviation between the sampled image data and the image data in the block R, and determining a set of values for e and f such that the deviation is small.

The above affine transformation has been described as mapping from block D to block R. To determine the coordinates of each pixel in the block D from the coordinates of the block R, the inverse transformation of the affine transformation is simply used.

When the blocks R and D are equal in aspect ratio to each other, examples of contour patterns of an object whose feature point is detectable are illustrated in FIG. 12. White dots are determined as the fixed points of mapping. Each of them coincides with the vertex of a corner. Thus, when the block R and the block D are equal in aspect ratio to each other, it is possible to detect the vertex of a corner having any angle.

In principle, the block D is allowed to be smaller than the block R as shown in FIG. 13. The state of the periphery of the fixed point in this case is illustrated in FIG. 14. The points on the invariant set moves outwards from the fixed point in radial directions; however, the overall shape of the invariant set remains unchanged from that of FIG. 11. Thus, the detectable feature points (the vertexes of corners) are still the same as those shown in FIG. 12. This indicates that, in this method, the shape itself of the invariant set is significant. The direction of movement of the points on the invariant set has little influence on the ability to detect the feature point. In other words, the direction of mapping is little significant.

In the above description, the direction of mapping is supposed to be from block D to block R. In the reverse mapping from block R to block D as well, the fixed point remains unchanged. The procedure of detecting the feature point in this case will be described below.

Here, the coefficients used in the above affine transformation are set such that a=d>1 and b=c=0.

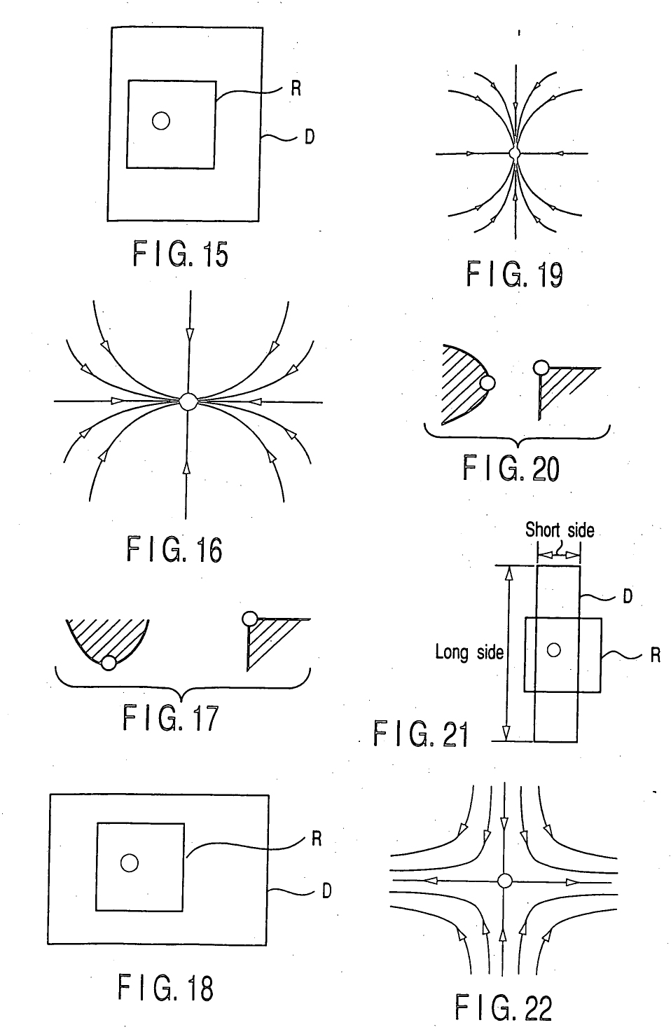

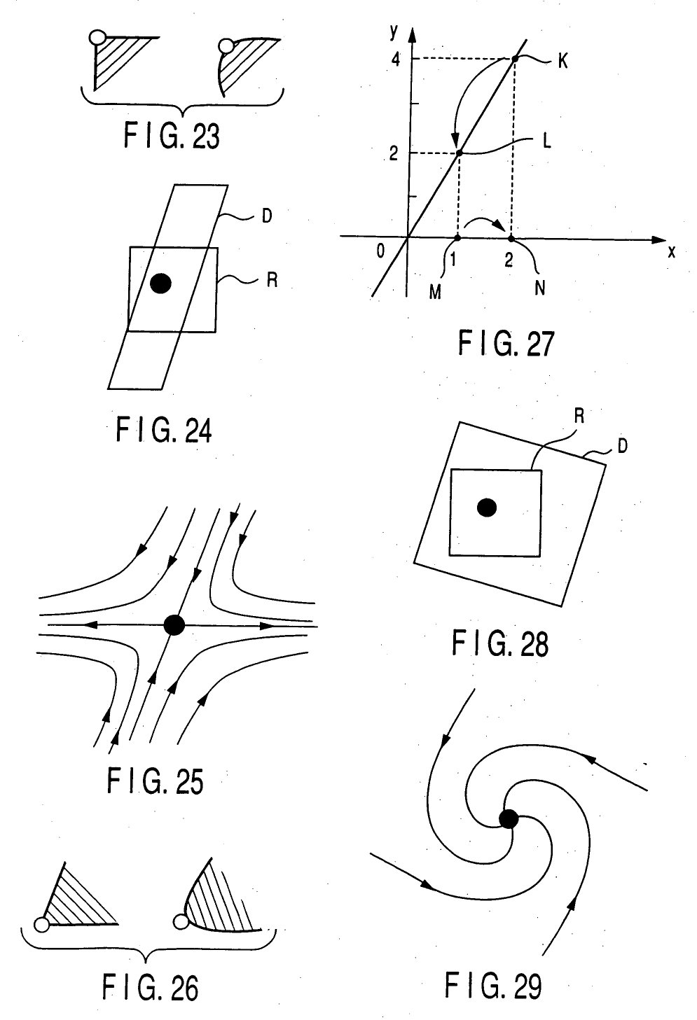

In FIGS. 15 to 20, there are illustrated examples in which the block R and the block D have different aspect ratios. In the example of FIG. 15, the block D is set up so that its shorter side lies at the top. In this case, the invariant set is as depicted in FIG. 16.

As can be seen from FIG. 16, the invariant set (quadratic curves) other than horizontal and vertical lines that intersect at the fixed point indicated by black dot touches the horizontal line at the fixed point. For convenience of description, the horizontal line is set parallel to the shorter side of the drawing sheet and the vertical line is set parallel to the longer side of the drawing sheet.

Thus, as shown in FIG. 17, the vertex of a U-shaped contour and a right-angled corner formed from the horizontal and vertical lines can be detected. FIG. 17 shows only typical examples. In practice, feature points on a figure composed of any combination of invariant sets shown in FIG. 16 can be detected. For example, contours that differ in curvature from the U-shaped contour shown in FIG. 17, inverse-U-shaped contours and L-shaped contours are objects of detection. The affine transformation coefficients in this case are d<a<1 and b=c=0.

FIG. 18 shows an example in which the block D is set up so that its longer side lies at the top. In this case, the invariant set touches the vertical line at the fixed point as shown in FIG. 19. The detectable shapes are as depicted in FIG. 20. The affine transformation coefficients in this case are a<d<1 and b=c=0.

Next, FIG. 21 shows an example in which the block D is larger in length and smaller in width than the block R. The invariant set in this case is as depicted in FIG. 22. Thus, the detectable shapes are right-angled corners formed from the horizontal and vertical lines and more gentle corners as shown in FIG. 22. In this example, other corners than right-angled corners (for example, corners having an angle of 45 degrees) cannot be detected.

Man-made things, such as buildings, window frames, automobiles, etc., have many right-angled portions. To detect only such portions with certainty, it is recommended that blocks be set up as shown in FIG. 21. By so doing, it becomes possible to prevent corners other than right-angled corners from being detected in error.

When the resolution is insufficient at the time of shooting images, the right angle may be blunted. According to this example, even blunt right angle can be detected advantageously. The affine transformation coefficients in this case are d<1<a and b=c=0.

FIG. 24 shows an example in which the block D is distorted sideways (oblique rectangle) in FIG. 21. The invariant set and the detectable shapes in this case are illustrated in FIGS. 25 and 26, respectively. This example allows corners having angles other than 90 degrees to be detected. This is effective in detecting corners whose angles are known beforehand.

A description is given of the way to determine the affine transformation coefficients a, b, c, and d used in detecting the feature point in a corner consisting of two straight lines each given a slope in advance. For the transformation in this case, it is sufficient to consider the following:
x_new=a*x_old+b*y_old,
y_new=c*x_old+d*y_old,

Let us consider two straight lines that intersect at the origin (a straight line having a slope of 2 and the x axis the slope of which is zero) as shown in FIG. 27. Two points are then put on each of the straight lines (points K(Kx, Ky), L(Lx, Ly); and points M(Mx, My), N(Nx, Ny)). Supposing that the point K is mapped to the point L and the point M to the point N, the above transformation is represented by
Lx=a*Kx+b*Ky,
Ly=c*Kx+d*Ky,
Nx=a*Mx+b*My,
Ny=c*Mx+d*My

By solving these simultaneous equations, a, b, c and d are determined. Since K(2, 4), L(1, 2), M(1, 0) and N(2, 0) in FIG. 27, a=2, b=− 3/4, c=0, and d=½.

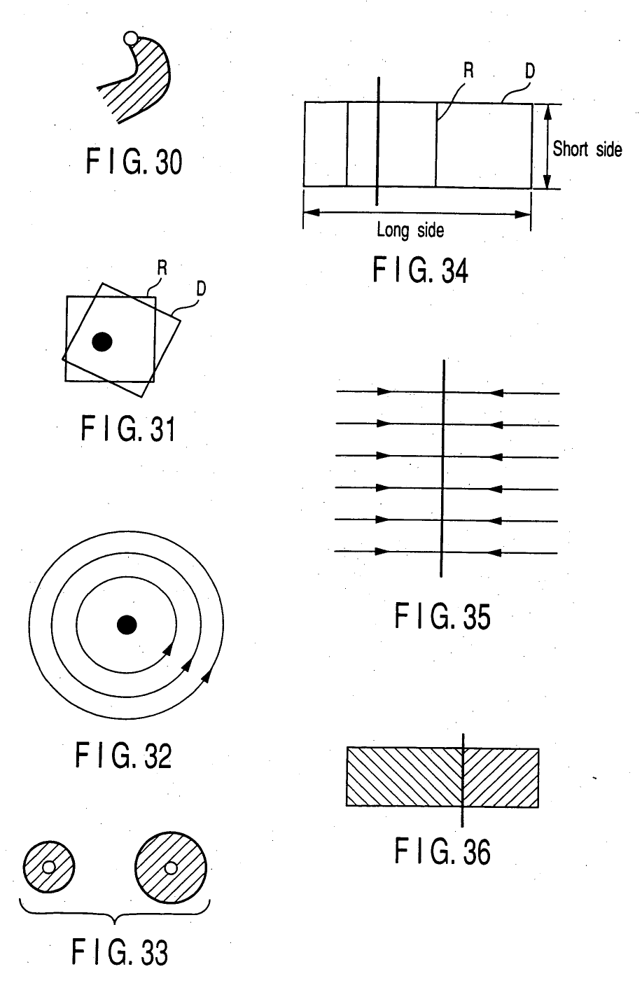

FIG. 28 shows an example in which the block D is tilted relative to the block R. In this case, the invariant set is as depicted in FIG. 29, allowing the vertex of such a spiral contour as shown in FIG. 30 to be detected.

FIG. 31 shows an example in which the block D is the same size as the block R and tilted relative to the block R. In this case, the invariant set is represented by circles centered at the fixed point as shown in FIG. 32, thus allowing the center of circles to be detected as the fixed point.

FIG. 34 shows an example in which the block D, which is rectangular in shape, is set up such that its long and short sides are respectively larger than and equal to the side of the block R square in shape. In this case, the invariant set consists of one vertical line and horizontal lines. In this example, a border line in the vertical direction of the image can be detected as shown in FIG. 36.

According to the fifth embodiment described above, in detecting one point within a set of points representing the shape of an object from an input image to be detected as the feature point representing the feature of that shape, a block of interest (block R) consisting of a rectangle containing at least one portion of the object is put on the input image and a search is then made for a region (block D) similar to the region of interest through operations using image data in that portion of the object. Mapping from the similar region to the region of interest or from the region of interest to the similar region is carried out and the fixed point in the mapped region is then detected as the feature point.

Thus, the use of the similarity relationship between rectangular blocks allows various feature points, such as vertexes of corners, etc., to be detected.

In the present invention, the image in which feature points are to be detected is not limited to an image obtained by electronically shooting physical objects. For example, when information for identifying feature points is unknown, the principles of the present invention are also useful to images such as graphics artificially created on computers. In this case, graphics are treated as objects.

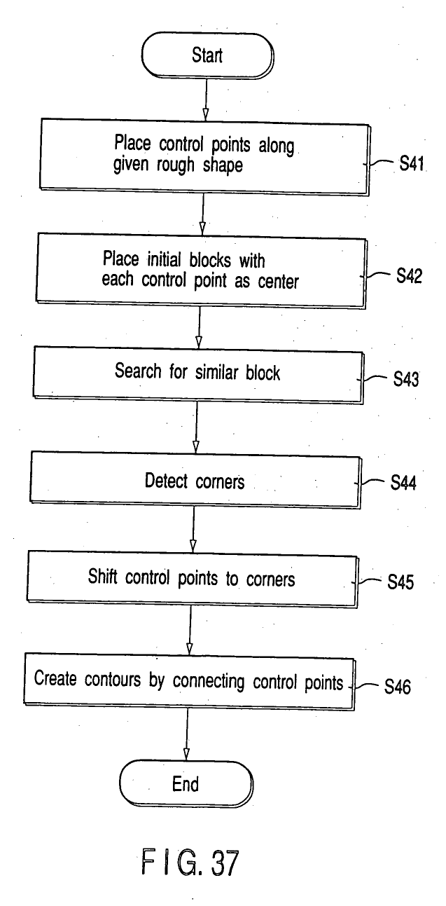

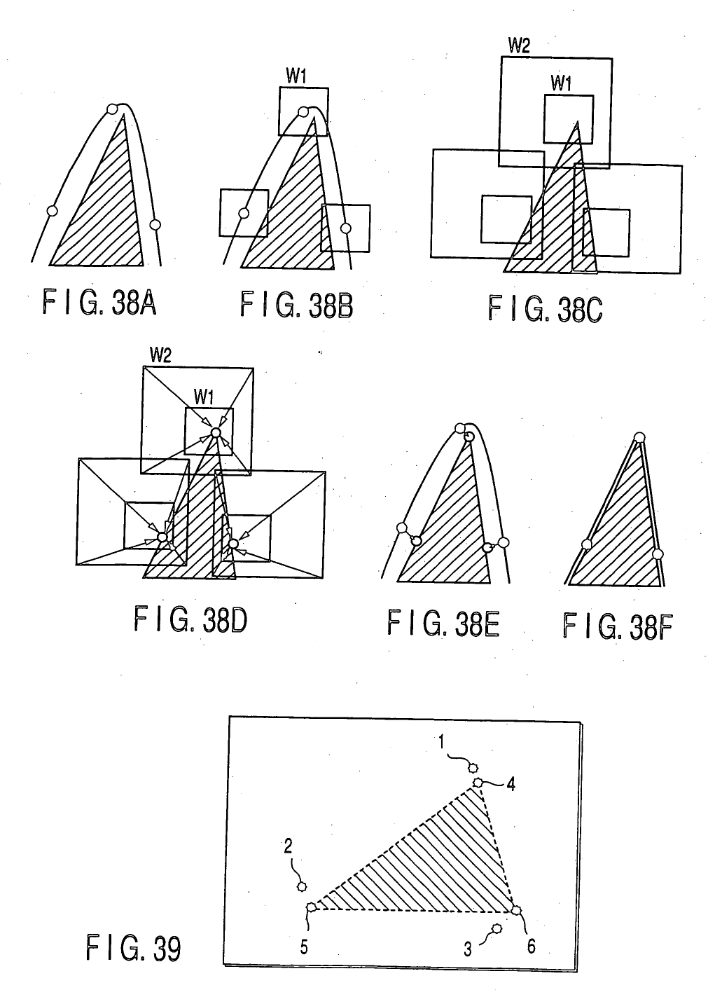

The corner detecting method of the fifth embodiment can be applied to the extraction of contours. Hereinafter, as a sixth embodiment of the present invention, a method of extracting contours using the corner detection of the fifth embodiment will be described with reference to FIGS. 37 and 38A through 38F. FIG. 37 is a flowchart illustrating the flow of image processing for contour extraction according to this embodiment. FIGS. 38A to 38F illustrate the operation of each step in FIG. 37.

First, as shown in FIG. 38A, a plurality of control points (indicated by black dots) are put at regular intervals along a previously given rough shape (step S41). Next, as shown in FIG. 38B, initial blocks W1 are put with each block centered at the corresponding control point (step S42).

Next, a search for similar blocks W2 shown in FIG. 38C (step S43) and corner detection shown in FIG. 38D (step S44) are carried out in sequence. Further, as shown in FIG. 38E, each of the control points is shifted to a corresponding one of the detected corners (step S45).

According to this procedure, even in the absence of corners in the initial blocks W1, points on the contour are determined as intersection points, allowing the control points to shift onto the contour as shown in FIG. 38E. Thus, the contour can be extracted by connecting the shifted control points by straight lines or spline curves (step S46).

With the previously described snake method as well, it is possible to extract contours by putting control points in the above manner and shifting them so that a energy function becomes small. However, the straighter the control points are arranged, the smaller the energy function becomes (so as to keep the contour smooth). Therefore, the corners of objects can be detected with little correctness. The precision with which the corner is detected can be increased by first extracting the contour through the snake method and then detecting the corner with the extracted contour as the rough shape in accordance with the above-described method.

When the shape of an object is already known to be a polygon such as a triangle or quadrangle, there is a method of representing the contour of the object by entering only points in the vicinity of the vertexes of the polygon through manual operation and connecting the vertexes with lines. The manual operation includes an operation of specifying the position of each vertex by clicking a mouse button on the image of an object displayed on a personal computer. In this case, specifying the accurate vertex position requires a high degree of concentration and experience. It is therefore advisable to, as shown in FIG. 39, specify the approximate positions 1, 2 and 3 of the vertexes with the mouse, placing the blocks W1 on those points to detect the corners in accordance with the above method, and shift the vertexes to the detected corner positions. This can significantly reduce the work load.

With the corner detecting method of this embodiment, as the initial block W1 increases in size, the difficulty involved in searching for a completely similar region increases; thus, if the initial block W1 is large, the similar block W2 will be displaced in position, resulting in corners being detected with displacements in position. However, unless the initial block W1 is large to the extent that the contours of an object are included within that block, it is impossible to search for the similar block W2.

This problem can be solved by changing the block size in such a way as to first set an initial block large in size to detect positions close to corners and then place smaller blocks in those positions to detect the corner positions. This approach allows contours to be detected accurately even when a rough shape is displaced from the correct contours.

With this corner detecting method, in determining the block W2 similar to the initial block W1, block matching is used to search for the similar block W2 such that the error in brightness within the blocks W1 and W2 is minimum. However, depending on the shape of contours of an object and the brightness pattern in the vicinity thereof, no similar region may be present. To solve this problem, switching is made between the control point shifting methods utilizing an error in brightness in the block matching as a value for evaluation of the reliability of similar-block searching; in the case of high reliability, the corner detecting method is used to shift the control points, and, in the case of low reliability, the energy function minimizing snake method is used. Thereby, an effective contour extraction method can be chosen for each part of contours of an object, allowing the contours of an object to be extracted with more precision.

The inventive image processing described above can be implemented in software for a computer. The present invention can therefore be implemented in the form of a computer-readable recording medium stored with a computer program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing method comprising:
extracting a feature pattern from an input image that depicts an object;
extracting a feature pattern from a reference image corresponding to the input image, the reference image being generated in advance of the input image; and
comparing the extracted feature pattern of the input image and the extracted feature pattern of the reference image to detect a change in the object.
